(19) United States
(12) Patent Application Publication
(10) Pub. No.: US 2025/0100618 A1
(43) Pub. Date: Mar. 27, 2025

(54) VEHICLE CONTROL SYSTEM, VEHICLE CONTROL METHOD, AND NON-TRANSITORY COMPUTER-READABLE STORAGE MEDIUM STORING PROGRAM FOR PERFORMING METHOD

(71) Applicant: HL MANDO CORPORATION, Gyeonggi-do (KR)

(72) Inventor: Jinsoo KIM, Gyeonggi-do (KR)

(21) Appl. No.: 18/827,672

(22) Filed: Sep. 7, 2024

(30) Foreign Application Priority Data
Sep. 25, 2023 (KR) 10-2023-0128094

(51) Int. Cl. B62D 9/00; B60T 8/171; B60T 8/172; B60T 8/26; B60W 10/184; B60W 10/20; B60W 30/18

(52) U.S. Cl. CPC B62D 9/005; B60T 8/171; B60T 8/172; B60T 8/26; B60W 10/184; B60W 10/20; B60W 30/18145; B60T 2210/12; B60T 2210/20; B60T 2220/00; B60T 2250/03; B60T 2260/02; B60W 2510/20; B60W 2520/14; B60W 2540/18; B60W 2710/18; B60W 2710/207; B60W 2720/14

(57) ABSTRACT

A vehicle body control system, a control method of the vehicle body control system, and a non-transitory computer-readable storage medium storing a program for performing the method may alleviate deterioration of steering performance of a vehicle when an electric power steering (EPS) system of the vehicle fails. The vehicle body control system includes a brake device configured to brake the vehicle, a detector configured to detect a failure of the EPS system, a steering sensor configured to detect an operation of a steering wheel of the vehicle to generate steering operation information, a controller configured to receive the steering operation information and generate a target yaw rate when the failure of the EPS system is detected, and control a brake device to generate a differential braking force required for the calculated target yaw rate.

### CROSS-REFERENCE TO RELATED APPLICATION

This application claims priority to and benefit from Korean Patent Application No. 10-2023-0128094, filed on Sep. 25, 2023, the disclosure of which is incorporated herein by reference in its entirety.

### BACKGROUND

### 1. Field

The present disclosure generally relates to a vehicle body control system, a control method of the vehicle body control system, and a non-transitory computer-readable storage medium storing a program for performing the method, and more specifically, to a vehicle body control system, a vehicle control method, and a non-transitory computer-readable storage medium capable of alleviating deterioration of steering performance of a vehicle when power assist is not properly performed due to a failure of an electric power steering (EPS) system of the vehicle.

### 2. Discussion of Related Art

In recent years, electric vehicle chassis system products such as an electric power steering (EPS) system have been commonplace in the automobile industry. The EPS system can assist a steering force acting between a rack and a pinion through control of a motor mounted on a steering column or rack side when a driver operates the steering wheel, thereby making the driver's steering operation easier.

However, with the increased lifespan of a vehicle, tendencies for system performance to deteriorate and for the frequency of failures to increase appear due to aging and fatigue of electronic components. As the vehicle ages, the output of the motor of the EPS system may decrease. In addition, when the vehicle is frequently driven on rough roads with high loads, such as unpaved roads, the decrease in the output of the motor of the EPS system or the failure of the EPS system motor may occur relatively earlier.

When the EPS system fails and thus power assist is lost or reduced, the driver has to respond to a large load that occurs between the ground and wheels of the vehicle using only the driver's own power when steering. Accordingly, the vehicle may be pulled to one side or severe vibration may occur in the vehicle. Meanwhile, when unnecessary assist is provided due to a failure of the EPS system, sudden steering may occur when the driver operates the steering wheel, and therefore it may make the driver difficult to drive the vehicle. As described above, an EPS operation that is inconsistent with a driver's intention may cause serious problems in the safety of the vehicle.

Accordingly, there is a need to develop a function for ensuring minimum safety levels in the event of performance deterioration or failure of parts of the electric vehicle chassis system, such as the motor of the EPS system.

### SUMMARY

The present disclosure has been made to solve the aforementioned problems, and is directed to providing a vehicle body control system capable of alleviating deterioration of steering performance of a vehicle when a failure occurs in an EPS system of the vehicle and power assist for a driver's steering is lost, a control method of the vehicle body control system, and a non-transitory computer-readable storage medium storing a program for performing the method.

The objects of the present disclosure are not limited to the above-described objects, and other objects that are not mentioned will be able to be clearly understood by those skilled in the art to which the present disclosure pertains from the following description.

According to an aspect of the present disclosure, there is provided a vehicle body control system that alleviates deterioration of steering performance of a vehicle when an electric power steering (EPS) system of the vehicle fails, the vehicle body control system including a brake device configured to brake the vehicle, a detector configured to detect a failure of the EPS system, a steering sensor configured to detect one or more pieces of steering operation information related to operation of a steering wheel of the vehicle, a first controller configured to receive the steering operation information and generate a target yaw rate when the detector detects the failure, and generate differential braking information including a left side differential braking force or a right side differential braking force required to follow the target yaw rate, and a second controller configured to receive the differential braking information and control the brake device so that the left side differential braking force or the right side differential braking force is generated.

In the vehicle body control system according to the aspect of the present disclosure, the differential braking information may include the left side differential braking force when a direction of the target yaw rate is a direction in which the vehicle moves to the left, and the differential braking information may include the right side differential braking force when the direction of the target yaw rate is a direction in which the vehicle moves to the right.

In the vehicle body control system according to the aspect of the present disclosure, the steering operation information may include one or more of a rotation angle and torque of the steering wheel.

In the vehicle body control system according to the aspect of the present disclosure, the first controller may receive final steering state information about the vehicle as feedback and use the final steering state information as a correction factor when generating the differential braking information.

In the vehicle body control system according to the aspect of the present disclosure, the first controller may receive disturbance information regarding an external action occurring while the vehicle is traveling and use the disturbance information as a correction factor when generating the differential braking information.

In the vehicle body control system according to the aspect of the present disclosure, the disturbance information may include one or more of a friction force of a road on which the vehicle is traveling and a slope of the road.

In the vehicle body control system according to the aspect of the present disclosure, the final steering state information and the disturbance information may be transmitted to the first controller through a controller area network (CAN) of the vehicle.

The vehicle body control system according to the aspect of the present disclosure may further include a rear wheel steering device configured to steer rear wheels of the vehicle, and the first controller may further generate rear wheel steering information including a rear wheel steering angle of the rear wheel steering device required to follow the target yaw rate.

The vehicle body control system according to the aspect of the present disclosure may further include a third controller configured to receive the rear wheel steering information and control the rear wheel steering device so that the rear wheel steering angle is generated.

In the vehicle body control system according to the aspect of the present disclosure, when the steering operation information meets a predetermined condition, the first controller may set the left side differential braking force and the right side differential braking force to 0 and set the rear wheel steering angle to an angle in reverse phase to a steering direction of the vehicle.

In the vehicle body control system according to the aspect of the present disclosure, the steering operation information may include a rotation angle of the steering wheel, and the predetermined condition may be set such that the rotation angle is less than or equal to a predetermined angle.

In the vehicle body control system according to the aspect of the present disclosure, when the steering operation information does not meet the predetermined condition, the first controller may set the left side differential braking force or the right side differential braking force to a value other than 0 and set the rear wheel steering angle to the angle in reverse phase to the steering direction of the vehicle.

According to another aspect of the present disclosure, there is provided a control method of a vehicle body control system that alleviates deterioration of steering performance of a vehicle when an electric power steering (EPS) system of the vehicle fails, the control method including detecting, by a detector, a failure of the EPS system, receiving, by a first controller, one or more pieces of steering operation information related to operation of a steering wheel of the vehicle and generating a target yaw rate when the detector detects the failure, generating, by the first controller, differential braking information including a left side differential braking force or a right side differential braking force required to follow the target yaw rate, and transmitting, by the first controller, the differential braking information to a second controller configured to control a brake device for braking the vehicle.

In the control method of a vehicle body control system according to the aspect of the present disclosure, the differential braking information may include the left side differential braking force when a direction of the target yaw rate is a direction in which the vehicle moves to the left, and the differential braking information may include the right side differential braking force when the direction of the target yaw rate is a direction in which the vehicle moves to the right.

The control method of a vehicle body control system according to the aspect of the present disclosure may further include generating, by the first controller, rear wheel steering information including a rear wheel steering angle required to follow the target yaw rate, and transmitting, by the first controller, the rear wheel steering information to a third controller configured to control a rear wheel steering device for steering rear wheels of the vehicle.

In the control method of a vehicle body control system according to the aspect of the present disclosure, when the steering operation information meets a predetermined condition, the first controller may set the left side differential braking force and the right side differential braking force to 0 in the generating of the differential braking information, and the first controller may set the rear wheel steering angle to an angle in reverse phase to a steering direction of the vehicle in the generating of the rear wheel steering information.

In the control method of a vehicle body control system according to the aspect of the present disclosure, the steering operation information may include a rotation angle of the steering wheel, and the predetermined condition may be set such that the rotation angle is less than or equal to a predetermined angle.

In the control method of a vehicle body control system according to the aspect of the present disclosure, when the steering operation information does not meet the predetermined condition, the first controller may set the left side differential braking force or the right side differential braking force to a value other than 0 in the generating of the differential braking information, and the first controller may set the rear wheel steering angle to the angle in reverse phase to the steering direction of the vehicle in the generating of the rear wheel steering information.

In the control method of a vehicle body control system according to the aspect of the present disclosure, in the generating of the differential braking information, the first controller may generate the differential braking information using final steering state information about the vehicle and disturbance information regarding an external action occurring while the vehicle is traveling as correction factors, and in the generating of the rear wheel steering information, the first controller may generate the rear wheel steering information using the final steering state information and the disturbance information as correction factors.

In the control method of a vehicle body control system according to the aspect of the present disclosure, the disturbance information may include one or more of a friction force of a road and a slope of the road.

According to still another aspect of the present disclosure, there is provided a non-transitory computer-readable storage medium storing a program including at least one instruction for performing the control method of a vehicle body control system according to one aspect of the present disclosure.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a configuration of a vehicle body control system according to one embodiment of the present disclosure;

FIG. 2 is a block diagram illustrating a detailed configuration of a first controller of a vehicle body control system according to one embodiment of the present disclosure;

FIG. 3 illustrates a first example of a vehicle body control operation performed by a vehicle body control system when a predetermined condition is met and a vehicle is steered to the right according to one embodiment of the present disclosure;

FIG. 4 illustrates a second example of a vehicle body control operation performed by a vehicle body control system when a predetermined condition is met and a vehicle is steered to the left according to one embodiment of the present disclosure;

FIG. 5 illustrates a third example of a vehicle body control operation performed by a vehicle body control system when a predetermined condition is not met and a vehicle is steered to the right according to one embodiment of the present disclosure;

FIG. 6 illustrates a fourth example of a vehicle body control operation performed by a vehicle body control system when a predetermined condition is not met and a vehicle is steered to the left according to one embodiment of the present disclosure;

FIG. 7 is a flowchart of a control method of a vehicle body control system according to one embodiment of the present disclosure;

FIG. 8 is a graph for illustrating steering torque of a steering wheel according to various vehicle body control states in a J-turn steering motion; and

FIG. 9 is a graph for illustrating driving trajectories of a vehicle according to various vehicle body control states in a J-turn steering motion.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

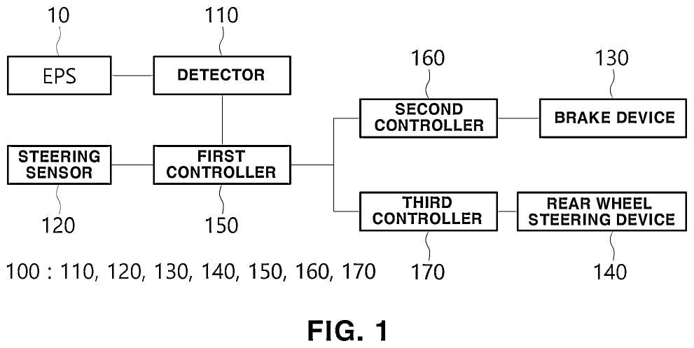

FIG. 1 is a block diagram illustrating a configuration of a vehicle body control system according to one embodiment of the present disclosure.

An electric power steering (EPS) system 10 is installed in a vehicle and may be configured to assist steering force of a driver of the vehicle. For example, when the driver of the vehicle operates a steering wheel, the EPS system 10 assists a steering force acting between a rack and a pinion in a steering mechanism through control of a motor mounted on a steering column or rack side, thereby making the driver easy to steer.

When a failure occurs in the EPS system 10, an appropriate steering assistance force may not be provided when the driver operates the steering wheel. Accordingly, the failure of the EPS system 10 may cause difficulty for the driver to steer the vehicle, and may occur serious safety problems.

A vehicle body control system 100 according to one embodiment of the present disclosure may alleviate deterioration of steering performance of the vehicle when the EPS system 10 of the vehicle fails and power assist for the driver's steering is lost. The vehicle body control system 100 according to one embodiment of the present disclosure may provide an appropriate steering assistance force for the driver's steering in a situation where the steering assistance force may not be provided due to a failure of the EPS system 10.

The vehicle body control system 100 according to one embodiment of the present disclosure may be installed in the vehicle. Referring to FIG. 1, the vehicle body control system 100 according to one embodiment of the present disclosure may include a detector 110, a steering sensor 120, a brake device 130, a rear wheel steering device 140, a first controller 150, a second controller 160, and a third controller 170.

The detector 110 may be configured to detect a failure of the EPS system 10. For example, the detector 110 may configured to sense a steering assistance force provided to the driver. When the steering assistance force is not provided to the driver due to the failure of the EPS system 10, the detector 110 may detect the failure of the EPS system 10 and transmit a detection result to the first controller 150.

The EPS system 10 may include various components such as a motor for generating a steering assistance force, a control unit or controller for controlling the motor, a rack for transmitting the steering assistance force to wheels, and one or more sensors for detecting one or more of the vehicle's speed, steering angle, and/or other factors.

When the motor of the EPS system 10 fails, the failure of the motor may occur in the EPS system 10. For example, when brushes of the motor are worn, current may not be properly transmitted, thereby reducing the output of the motor. Further, when bearings included in the motor are worn, a rotor may not normally rotate.

When the control unit or controller of the EPS system 10 fails, a failure of the EPS system 10 may occur. The control unit or controller of the EPS system 10 is configured to interpretate sensor data and transmitting commands to the motor in the EPS system 10, and when the control unit or controller of the EPS system 10 misinterprets the sensor data or outputs an abnormal motor control command due to the failure thereof, a failure may occur in the EPS system 10.

Even when one or more parts of the EPS system 10 fail, a failure may occur in the EPS system 10. For example, when a part such as a steering rack is damaged by impact to the vehicle, foreign substances, or the like, the EPS system 10 may not normally operate because the steering assistance force provided by the motor may not be transmitted to the wheels of the vehicle.

Even when one or more sensors included in or associated with the EPS system 10 fail, a failure may occur in the EPS system 10. For example, when data on one or more of the speed, steering angle, and other factors of the vehicle may not be properly collected due to the failure of a sensor, the control unit or controller may not be able to output appropriate motor control commands. Accordingly, normal operation of the EPS system 10 becomes difficult.

The detector 110 may detect a failure occurring in the motor, the control unit or controller, sensors, and any part of the EPS system 10. For example, the detector 110 may include one or more of one or more sensors, one or more detector controllers, and/or the like for detecting a failure occurring in the EPS system 10. The detector controller may be a micro controller unit (MCU) or a processor for processing one or more algorithms for detecting a failure in the EPS system 10.

The steering sensor 120 may detect operation of the steering wheel of the vehicle to generate one or more pieces of steering operation information related to the operation of the steering wheel of the vehicle. For example, the steering operation information may include the rotation angle of the steering wheel operated by the driver of the vehicle and/or the torque of the steering wheel manipulated by the driver of the vehicle. The steering sensor 120 may include, for example, but not limited to, a rotation angle sensor and/or a torque sensor.

The brake device 130 may be configured to perform a brake operation to brake the vehicle. In one embodiment of the present disclosure, the brake device 130 may inhibit or slow down the rotation of one or more of the wheels of the vehicle. For instance, the brake device 130 may be hydraulically or electronically configured.

When the brake device 130 brakes only the left wheel of the vehicle, left side differential braking may be performed. In addition, when the brake device 130 brakes only the right wheel of the vehicle, right side differential braking may be performed.

When an appropriate steering assistance force for steering to the left is not provided to the steering wheel for assist the driver's steering due to a failure of the EPS system 10, a left steering assistance force may be provided or obtained by performing the left side differential braking by the brake device 130. When an appropriate steering assistance force for steering the right is not provided to the driver due to the failure of the EPS system 10, a right steering assistance force may be provided or obtained by performing the right side differential braking by the brake device 130.

The rear wheel steering device 140 actively controls a steering angle of the rear wheels to correspond to a steering angle of the front wheels according to a driving situation of the vehicle. The rear wheel steering device 140 may reduce a turning radius of the vehicle by steering the rear wheels in a direction opposite to a steering direction of the front wheels, that is, in reverse phase.

Meanwhile, the rear wheel steering device 140 may steer the rear wheels in the same direction as the front wheels, that is, in phase, when the vehicle is traveling at high speed. When the rear wheel steering device 140 steers the rear wheels and the front wheels in the same direction as each other when the vehicle is traveling at high speed, the stability of turning driving may be improved.

When the detector 110 detects a failure of the EPS system 10, the first controller 150 receives steering operation information from the steering sensor 120 and determines or generates a target yaw rate of the vehicle. The first controller 150 may be, for instance, but not limited to, a micro controller unit (MCU) or a processor for processing one or more algorithms.

When the detector 110 detects the failure of the EPS system 10, failure detection information is transmitted to the first controller 150 from the detector 110. In addition, the first controller 150 may receive one or more pieces of steering operation information related to the steering wheel operation of the vehicle from the steering sensor 120.

In response to the detection of the failure of the EPS system 10, the first controller 150 generates differential braking information including a left side differential braking force or a right side differential braking force required to steer the vehicle at the target yaw rate. The first controller 150 may transmit the differential braking information to the second controller 160. The brake device 130 of the vehicle can generate differential braking based on the differential braking information received from the first controller 150.

When the first controller 150 generates differential braking information for generating a left side differential braking force, the brake device 130 may perform a brake operation to generate a left side differential braking force in the vehicle in order to provide a left steering assistance force to the vehicle. In addition, when the first controller 150 generates differential braking information for generating a right side differential braking force, the brake device 130 may perform another brake operation to generate a right side differential braking force in the vehicle in order to provide a right steering assistance force to the vehicle.

In other words, in one embodiment of the present disclosure, when the direction of the target yaw rate determined by the first controller 150 is a direction in which the vehicle moves to the left, the differential braking information generated by the first controller 150 may cause the brake device 130 to generate the left side differential braking force. In addition, when the direction of the target yaw rate determined by the first controller 150 is a direction in which the vehicle moves to the right, the differential braking information generated by the first controller 150 may cause the brake device 130 to generate the right side differential braking force.

Meanwhile, the first controller 150 may generate rear wheel steering information including a rear wheel steering angle of the rear wheel steering device 140 required to steer the vehicle at the target yaw rate. For example, the first controller 150 may set the rear wheel steering angle to an angle in a direction opposite to a steering direction of the vehicle (e.g. in a reverse phase) to steer the rear wheels in a direction opposite to the steering direction of the vehicle.

The first controller 150 may transmit the rear wheel steering information to the third controller 170. The rear wheel steering device 140 can perform the steering of the rear wheels based on the rear wheel steering information.

In one exemplary embodiment of the present disclosure, the rear wheel steering information may have priority over the differential braking information. The first controller 150 may utilize the rear wheel steering information in priority over the differential braking information to compensate for the loss of a steering assistance force caused by a failure of the EPS system 10. This is because the generation of a steering assistance force by rear wheel steering is preferable in terms of efficiency or ride quality compared to the generation of a steering assistance force by differential braking.

Hereinafter, the generation of the differential braking information and the rear wheel steering information by the first controller 150 will be described in more detail.

First, when the steering operation information meets a predetermined condition, the first controller 150 may set the left side differential braking force and the right side differential braking force to 0 and set the rear wheel steering angle to an angle for steering the rear wheels in a direction opposite to the steering direction of the vehicle (i.e, an angle in reverse phase to the steering direction of the vehicle).

The predetermined condition may be a condition for a state in which the loss of a steering assistance force can be compensated for only by rear wheel steering. In this case, the rear wheel steering angle is set to the angle in reverse phase to the steering direction of the vehicle, thereby reducing the turning radius of the vehicle and assisting steering.

As described above, the steering operation information may include the rotation angle of the steering wheel. In this case, the predetermined condition may be set such that the rotation angle is less than or equal to a predetermined angle. For example, the rotation angle may be selected between 15 and 20 degrees for reducing the turning radius of the vehicle and efficiently performing the assisting steering.

However, when the steering operation information does not meet the predetermined condition, the first controller 150 may set the left side differential braking force or the right side differential braking force to a value other than 0 and set the rear wheel steering angle to the angle in reverse phase to the steering direction of the vehicle.

The failure of satisfying the predetermined condition may be a state in which the loss of a steering assistance force cannot be sufficiently compensated for only by rear wheel steering. For example, when the rotation angle of the steering wheel is set to be equal to or less than a predetermined angle, the failure of meeting the predetermined condition may mean a situation in which the vehicle has to be relatively rapidly steered.

In this case, it may be difficult to sufficiently compensate for the loss of a steering assistance force caused by a failure of the EPS system 10 only by rear wheel steering by the rear wheel steering device 140. In this case, the first controller 150 may set the left side differential braking force or the right side differential braking force to a value other than 0 and set the rear wheel steering angle to the angle in reverse phase to the steering direction of the vehicle, thereby allowing the steering assistance force to be compensated by not only the rear wheel steering but also the differential braking even during relatively sudden steering.

In this way, when a failure occurs in the EPS system 10, the first controller 150 may integrally or simultaneously generate the differential braking information and the rear wheel steering information. As a result, the loss of a steering assistance force caused by the failure of the EPS system 10 may be effectively compensated by performing both the differential braking of the brake device 130 of the vehicle and the rear wheel steering of the rear wheel steering device 140.

However, if the vehicle is not equipped with the rear wheel steering device 140, the first controller 150 may generate the differential braking information, but the first controller 150 may not generate the rear wheel steering information. Accordingly, when a failure of the EPS system 10 occurs, the loss of a steering assistance force may be compensated for only by the differential braking.

Meanwhile, in one embodiment of the present disclosure, the first controller 150 may receive final steering state information about the vehicle as feedback and use the final steering state information as a correction factor when generating the differential braking information. Further, the first controller 150 may receive the final steering state information about the vehicle as feedback and use the final steering state information as a correction factor when generating the rear wheel steering information.

The first controller 150 may receive disturbance information regarding an external action occurring while the vehicle is traveling and use the disturbance information as a correction factor when generating the differential braking information. In addition, the first controller 150 may receive the disturbance information regarding the external action occurring while the vehicle is traveling and use the disturbance information as a correction factor when generating the rear wheel steering information.

In this case, the disturbance information may include, for example, but not limited to, a friction force of a road on which the vehicle is traveling and a slope of the road.

In one embodiment of the present disclosure, the final steering state information and the disturbance information may be transmitted to the first controller 150 through a controller area network (CAN) of the vehicle.

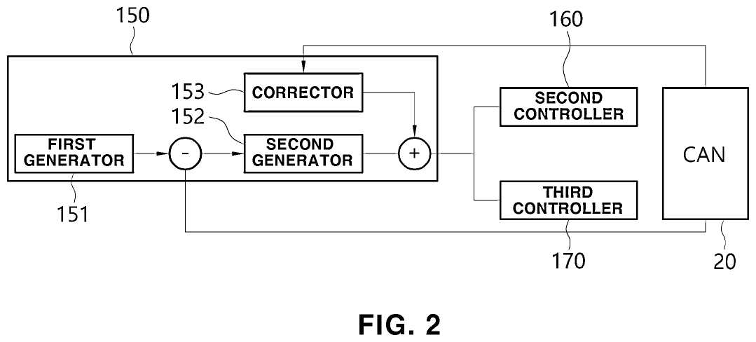

FIG. 2 is a block diagram for illustrating a detailed configuration of a first controller of a vehicle body control system according to one embodiment of the present disclosure.

Referring to FIG. 2, the first controller 150 of the vehicle body control system 100 according to one embodiment of the present disclosure may include a first generator 151, a second generator 152, and a corrector 153. Here, the first generator 151, the second generator 152, and the corrector 153 may not be physically separate components, but may be logically separate components within the MCU. Further, the first generator 151, the second generator 152, and the corrector 153 may be implemented as software modules which can be processed by one or more processors.

The first generator 151 receives one or more pieces of steering operation information related to steering wheel operation of the vehicle and generates a target yaw rate. In one embodiment of the present disclosure, the first generator 151 may receive the steering operation information from the steering sensor 120.

The second generator 152 generates differential braking information including a left side differential braking force or a right side differential braking force required to steer the vehicle at the target yaw rate. In addition, the second generator 152 may generate rear wheel steering information including a rear wheel steering angle of the rear wheel steering device 140 required to steer the vehicle at the target yaw rate.

The differential braking information generated by the second generator 152 may be transmitted to the second controller 160. In addition, the rear wheel steering information generated by the second generator 152 may be transmitted to the third controller 170.

The second generator 152 may receive the final steering state information about the vehicle as feedback and use the final steering state information as a correction factor when generating the differential braking information. Further, the second generator 152 may receive the final steering state information about the vehicle as feedback and use the final steering state information as a correction factor when generating the rear wheel steering information.

In other words, the second generator 152 may receive state-feedback and generate the differential braking information and the rear wheel steering information by reflecting the state-feedback.

For example, the second generator 152 is connected to the CAN 20 for communication, and the final steering state information may be transmitted to the second generator 152 through the CAN 20 of the vehicle.

The corrector 153 may receive the disturbance information and correct the differential braking information or the rear wheel steering information generated and output by the second generator 152 based on the disturbance information.

For instance, the corrector 153 is connected to the CAN 20 for communication, and the disturbance information may be transmitted to the corrector 153 through the CAN 20 of the vehicle.

As described above, the disturbance information is information related to external actions that occur while the vehicle is traveling. For example, the disturbance information may include a friction force of a road on which the vehicle is traveling and a slope of the road.

The second controller 160 receives the differential braking information and control the brake device 130 so that the left side differential braking force or the right side differential braking force is generated according to the differential braking information. For example, the second controller 160 may be an electronic control unit (ECU) configured to control the brake device 130.

According to the control of the second controller 160, the right side differential braking force or the left side differential braking force may be generated in the vehicle to compensate for the loss of a steering assistance force of the EPS system 10 by the generation of the differential braking force. For instance, the right side differential braking force generated by the control of the second controller 160 may cause to assist for the vehicle to be steered to the right, and the left side differential braking force generated by the control of the second controller 160 may cause to assist for the vehicle to be steered to the left.

The third controller 170 receives the rear wheel steering information and controls the rear wheel steering device 140 based on the rear wheel steering information to steer the rear wheels to the rear wheel steering angle. For example, the third controller 170 may be an electronic control unit (ECU) configured to control the rear wheel steering device 140.

The third controller 170 may receive the rear wheel steering information and control the rear wheel steering device 140 of the vehicle so that the rear wheels can be steered to a rear wheel steering angle corresponding to the rear wheel steering information in a direction opposite to the steering direction of the vehicle, in order to compensate for the loss of a steering assistance force of the EPS system 10.

In the foregoing, the configurations of the vehicle body control system 100 according to exemplary embodiments of the present disclosure have been described in detail. Hereinafter, operations of the vehicle body control system 100 according to exemplary embodiments of the present disclosure will be described in detail.

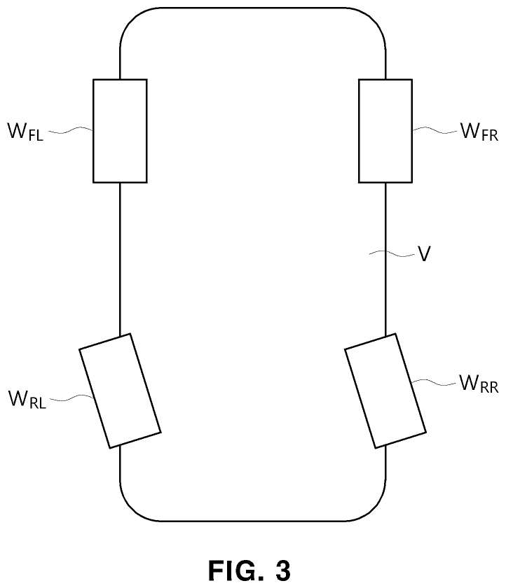

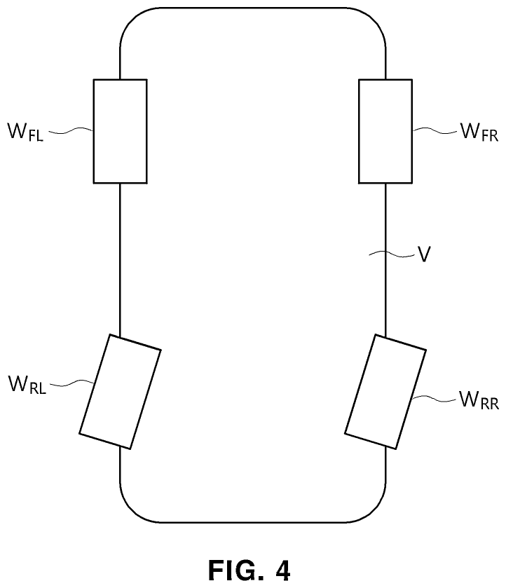

FIG. 3 illustrates a first example of a vehicle body control operation performed by a vehicle body control system according to one embodiment of the present disclosure when a predetermined condition is met and a vehicle is steered to the right. FIG. 4 illustrates a second example of a vehicle body control operation by a vehicle body control system according to one embodiment of the present disclosure when a predetermined condition is met and the vehicle is steered to the left.

The predetermined condition may be, for instance, but not limited to, a condition where a rotation angle of the steering wheel is less than or equal to a predetermined angle. For example, the predetermined angle for the rotation angle of the steering wheel may be preset to be any value between 15 and 20 degrees.

In FIGS. 3 and 4, states of a front left wheel W_{FL}, a front right wheel W_{FR}, a rear left wheel W_{RL}, and a rear right wheel W_{RR} of a vehicle V represent only control states by the vehicle body control system 100.

In the examples of FIGS. 3 and 4, the front left wheel W_{FL} and the front right wheel W_{FR} of the vehicle V are positioned in a straight direction due to the loss of a steering assistance force of the EPS system 10 because the front left wheel W_{FL} and the front right wheel W_{FR} are not steered at all even though the steering wheel is steered to the right or left by the driver of the vehicle, or the front left wheel W_{FL} and the front right wheel W_{FR} may not be steered such that the vehicle V is not steered to the right or left according to a driver's steering operation.

Referring to FIGS. 3 and 4, when a steering assistance force is not generated due to a failure in the EPS system of the vehicle V and the steering operation information meets the predetermined condition, the right side differential braking force and the left side differential braking force may be set to 0, and the rear wheel steering angle may be set to an angle in a direction opposite to the steering direction of the vehicle V.

In the example of FIG. 3, when the predetermined condition is met and the driver of the vehicle V steers the steering wheel to the right, the brake device 130 of the vehicle body control system 100 may not generate a differential braking force, and the rear wheel steering device 140 steers the rear left wheel W_{RL} and the rear right wheel W_{RR} to the left in order to provide compensation for a right steering assistance force to the vehicle V.

In the example of FIG. 4, when the predetermined condition is met and the driver of the vehicle V steers the steering wheel to the left, the brake device 130 of the vehicle body control system 100 may not generate differential braking force, and the rear wheel steering device 140 steers the rear left wheel W_{RL} and the rear right wheel W_{RR} to the right in order to provide compensation for a left steering assistance force to the vehicle V.

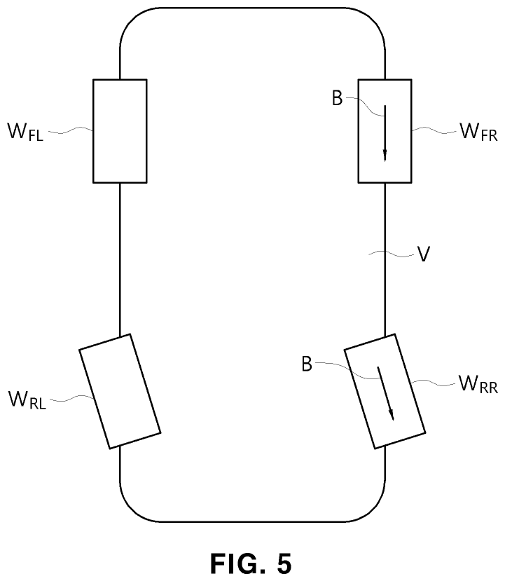

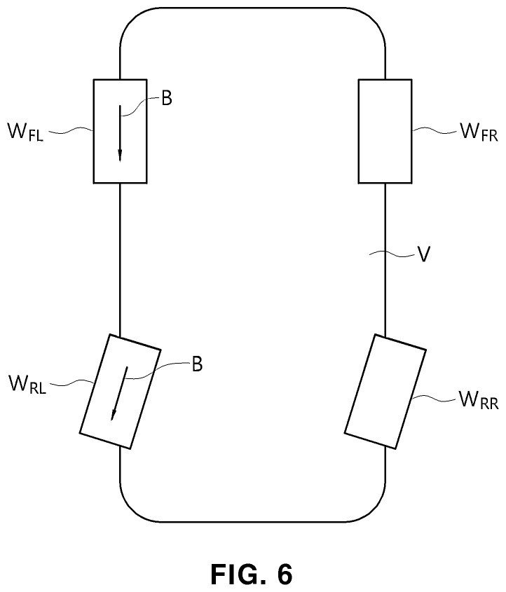

FIG. 5 illustrates a third example of a vehicle body control operation performed by a vehicle body control system according to one embodiment of the present disclosure when a predetermined condition is not met and a vehicle is steered to the right. FIG. 6 illustrates fourth example of a vehicle body control operation performed by a vehicle body control system according to one embodiment of the present disclosure when a predetermined condition is not met and a vehicle is steered to the left.

In FIGS. 5 and 6, states of the front left wheel W_{FL}, the front right wheel W_{FR}, the rear left wheel W_{RL}, and the rear right wheel W_{RR} of the vehicle V represent only control states by the vehicle body control system 100.

In the examples of FIGS. 5 and 6, the front left wheel W_{FL} and the front right wheel W_{FR} of the vehicle V are positioned in a straight direction due to the loss of a steering assistance force of the EPS system 10 because the front left wheel W_{FL} and the front right wheel W_{FR} are not steered at all even though the steering wheel is steered to the right or left by the driver of the vehicle, or the front left wheel W_{FL} and the front right wheel W_{FR} may not be steered such that the vehicle V is not steered to the right or left according to a driver's steering operation.

Referring to FIGS. 5 and 6, when a steering assistance force is not generated due to a failure in the EPS system of the vehicle V and the steering operation information does not meet the predetermined condition, the right side differential braking force and the left side differential braking force may be set to a value other than 0, and the rear wheel steering angle may be set to an angle in a direction opposite to the steering direction of the vehicle V.

The failure of satisfying the predetermined condition may include a case where the relatively sharp steering of the vehicle has to be performed. In this case, the rear wheel steering by the rear wheel steering device 140 may insufficient for sufficiently compensating for the loss of a steering assistance force due to the failure of the EPS system.

In this case, the vehicle body control system 100 may set the left side differential braking force or the right side differential braking force to a value other than 0 and set the rear wheel steering angle to an angle in a direction opposite to the steering direction of the vehicle, so that the steering assistance force can be compensated for at a certain level even during relatively sudden steering by a combination of the rear wheel steering and the differential braking.

For example, when the predetermined condition described above is not met and the driver of the vehicle V steers the steering wheel to the right, the brake device 130 of the vehicle body control system 100 generates a braking force B on each of the front right wheel W_{FR} and the rear right wheel W_{RR} so that the right side differential braking force can be generated, and the rear wheel steering device 140 steers the rear left wheel W_{RL} and the rear right wheel W_{RR} to the left (see FIG. 5). Accordingly, the right steering assistance force may be provided to the vehicle V.

Further, when the predetermined condition described above is not met and the driver of the vehicle V steers the steering wheel to the left, the brake device 130 of the vehicle body control system 100 generates the braking force B on each of the front left wheel W_{FL} and the rear left wheel W_{RL} so that the left side differential braking force is generated, and the rear wheel steering device 140 steers the rear left wheel W_{RL} and the rear right wheel W_{RR} to the right (see FIG. 6). Accordingly, the left steering assistance force may be provided to the vehicle V.

In the foregoing, the configuration and operation of the vehicle body control system 100 according to some exemplary embodiments of the present disclosure have been described. In the following, a control method of a vehicle body control system according to certain exemplary embodiments of the present disclosure will be described.

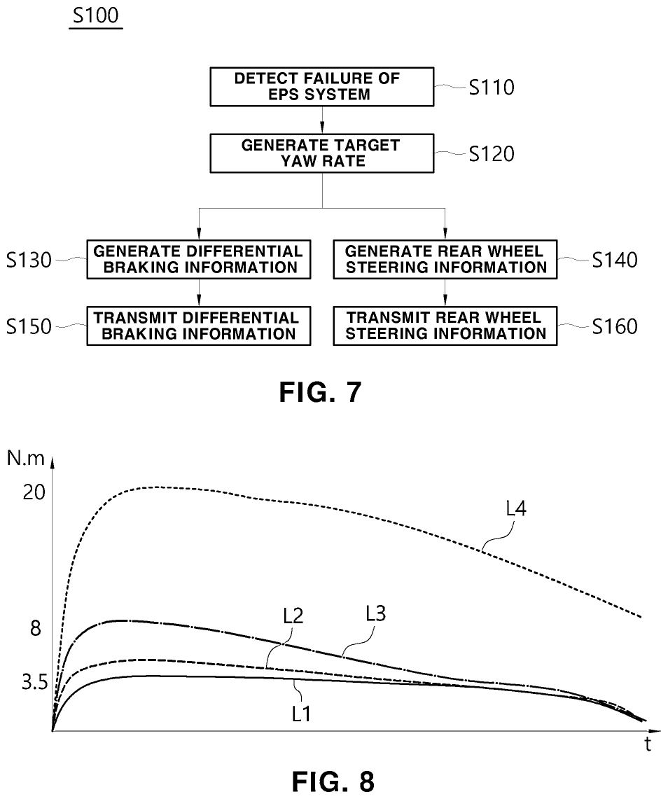

FIG. 7 is a flowchart of a control method of a vehicle body control system according to an embodiment of the present disclosure.

A control method (S100) of a vehicle body control system according to an embodiment of the present disclosure may alleviate deterioration of steering performance of the vehicle when an electric power steering (EPS) system of the vehicle fails. The control method (S100) of the vehicle body control system according to an embodiment of the present disclosure may be performed by the vehicle body control system 100 according to one embodiment of the present disclosure.

Referring to FIG. 7, the control method (S100) of the vehicle body control system according to an embodiment of the present disclosure may be performed as follows.

First, at operation S110, the detector 110 monitors or detects a failure of the EPS system 10. When a steering assistance force is not provided to the driver due to the failure of the EPS system 10, the detector 110 may detect the failure of the EPS system 10 and transmit a detection result to the first controller 150.

Next, at operation S120, the first controller 150 receives one or more pieces of steering operation information related to an operation of a steering wheel of the vehicle and determine or generates a target yaw rate of the vehicle. For example, the first controller 150 receives a detection result of the operation of the steering wheel from the detector 110 and generates the target yaw rate based on the steering operation information, the steering operation information may include, for example, but not limited to, one or more of the rotation angle and the torque of the steering wheel operated by the driver of the vehicle.

Next, at operation S130, the first controller 150 generates differential braking information including a left side differential braking force or a right side differential braking force required to follow the target yaw rate. The differential braking information may be utilized to generate differential braking through control of the brake device 130.

When the direction of the target yaw rate determined by the first controller 150 is a direction of moving the vehicle to the left, the differential braking information may include the left side differential braking force. In addition, when the direction of the target yaw rate determined by the first controller 150 is a direction of moving the vehicle to the right, the differential braking information may include the right side differential braking force.

Next, at operation S140, the first controller 150 generates rear wheel steering information including a rear wheel steering angle of the rear wheel steering device 140 required to follow the target yaw rate calculated by the first controller 150. The first controller 150 may set the steering angle of the rear wheels to an angle in a direction of opposite to a steering direction of the vehicle. The rear wheel steering information may be utilized for rear wheel steering through control of the rear wheel steering device 140.

Operation S130 of generating the differential braking information and operation S140 of generating the rear wheel steering information may be simultaneously performed by the first controller 150. Alternatively, one of operation S130 of generating the differential braking information and operation S140 of generating the rear wheel steering information may be performed first, and the other of operation S130 of generating the differential braking information and operation S140 of generating the rear wheel steering information may be performed later.

Next, at operation S150, the first controller 150 transmits the differential braking information to the second controller 160. The differential braking information is received by the second controller 160 for controlling the brake device 130.

The second controller 160 may receive the differential braking information and control the brake device 130 of the vehicle so that the left side differential braking force or the right side differential braking force can be generated. For instance, when the right side differential braking force is generated by the second controller 160, steering to the right may be assisted, and when the left side differential braking force is generated by the second controller 160, steering to the left may be assisted.

At operation S160, the first controller 150 transmits the rear wheel steering information to the third controller 170. The rear wheel steering information is received by the third controller 170 for controlling the rear wheel steering device 140.

The third controller 170 may receive the rear wheel steering information and control the rear wheel steering device 140 so that the rear wheels can be steered. The third controller 170 may receive the rear wheel steering information and control the rear wheel steering device 140 of the vehicle so that the rear wheels can be steered in a direction opposite to the steering direction of the vehicle. In this way, the loss of a steering assistance force of the EPS system due to the failure of the EPS system may be compensated by the rear wheel steering.

Operation S150 of transmitting the differential braking information to the second controller and operation S160 of transmitting the rear wheel steering information to the third controller 170 may be simultaneously performed. Alternatively, one of operation S150 of transmitting the differential braking information to the second controller and operation S160 of transmitting the rear wheel steering information to the third controller 170 may be performed first, and the other of operation S150 of transmitting the differential braking information to the second controller and operation S160 of transmitting the rear wheel steering information to the third controller 170 may be performed later.

For instance, when the steering operation information meets a predetermined condition, the first controller 150 may set the left side differential braking force and the right side differential braking force to 0 in operation S130 of generating the differential braking information and the first controller 150 may set the rear wheel steering angle to an angle in a direction opposite to a steering direction of the vehicle in operation S140 of generating the rear wheel steering information.

The predetermined condition may mean, for example, but not limited to, a state in which the loss of a steering assistance force due to the failure of the EPS system 10 may be compensated for only by rear wheel steering. In this case, when a steering angle of the rear wheels is set to an angle opposite to the steering direction of the vehicle, the steering may be assisted while the turning radius of the vehicle is reduced.

As described above, the steering operation information may include a rotation angle of the steering wheel, and the predetermined condition may be set such that the rotation angle is less than or equal to a predetermined angle.

Further, when the steering operation information does not meet the predetermined condition, the first controller 150 may set the left side differential braking force or the right side differential braking force to a value other than 0 in operation S130 of generating the differential braking information and the first controller 150 may set the rear wheel steering angle to an angle opposite to the steering direction of the vehicle in operation S140 of generating the rear wheel steering information.

The predetermined condition may mean, for instance, but not limited to, a state in which the loss of a steering assistance force due to the failure of the EPS system 10 may not be sufficiently compensated for only by rear wheel steering. For example, when the rotation angle is set to be less than the predetermined angle, the failure of meeting the predetermined condition may mean a state in which the vehicle has to be relatively rapidly steered.

In this case, it may be difficult to sufficiently compensate for the loss of a steering assistance force due to the failure of the EPS system only by the rear wheel steering performed by the rear wheel steering device 140. In this case, the first controller 150 may set the left side differential braking force or the right side differential braking force to a value other than 0 and set the rear wheel steering angle to an angle opposite to the steering direction of the vehicle, thereby allowing the steering assistance force to be compensated for at a certain level or higher even during relatively sharp steering through a combination of the differential braking and the rear wheel steering.

In addition, in operation S130 of generating the differential braking information, the first controller 150 may generate the differential braking information using final steering state information about the vehicle and disturbance information regarding an external action occurring while the vehicle is traveling as correction factors.

Further, in operation S140 of generating the rear wheel steering information, the first controller 150 may generate the rear wheel steering information using the final steering state information and the disturbance information as correction factors.

As described above, the disturbance information may include one or more of the friction force of the road and the slope of the road.

Meanwhile, according to some exemplary embodiments of the present disclosure, a non-transitory computer-readable storage medium may store a program for performing a control method of a vehicle body control system. Specifically, a non-transitory computer-readable storage medium storing a program including at least one instruction for performing a control method of a vehicle body control system may be provided according to an embodiment of the present disclosure.

In this case, the instructions may include not only machine code generated by a compiler but also high-level language code executable by a computer or processor.

Meanwhile, the storage medium may include a hardware device configured to store and execute program instructions, such as magnetic media such as hard disks, floppy disks, and magnetic tapes, optical recording media such as compact disk read-only memory (CD-ROM) and digital video disks (DVD), magneto-optical media such as floptical disks, ROM, RAM, flash memory, or the like.

FIG. 8 is a graph for illustrating steering torque of a steering wheel according to various vehicle body control states in a J-turn steering motion.

FIG. 8 shows, in the J-turn steering motion, a case (L1) in which the EPS system is normal, a case (L2) in which a failure occurs in the EPS system and both the differential braking control and the rear wheel steering control are performed according to an embodiment of the present disclosure, a case (L3) in which a failure occurs in the EPS system and only differential braking control is performed, and a case (L4) in which a failure occurs in the EPS system and no compensation control is performed.

Referring to FIG. 8, it can be seen that according to an embodiment of the present disclosure, steering torque of the steering wheel that makes a driver apply more force due to the loss of a steering assistance force caused by a failure of the EPS system may be effectively compensated for.

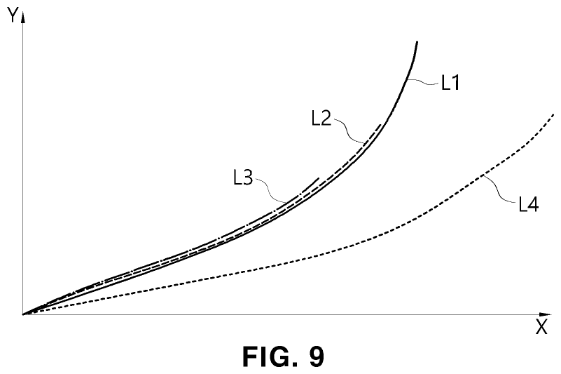

FIG. 9 is a graph illustrating driving trajectories of a vehicle according to various vehicle body control states in a J-turn steering motion.

FIG. 9 shows, in the J-turn steering motion, a case (L1) in which the EPS system is normal, a case (L2) in which a failure occurs in the EPS system and both the differential braking control and the rear wheel steering control are performed according to the present disclosure, a case (L3) in which a failure occurs in the EPS system and only differential braking control is performed, and a case (L4) in which a failure occurs in the EPS system and no compensation control is performed.

Referring to FIG. 9, it can be seen that according to the present disclosure, even when a steering assistance force is lost due to a failure of the EPS system, the total moving distance of the driving trajectory may be minimized to be close to a state in which the EPS is normal.

As discussed above, according to certain embodiments of the present disclosure, it is possible to assist a driver's steering torque and maintain steerability of the vehicle through integrated control of differential braking (steer by brake (SbB)) and rear wheel steering (RWS) when an EPS system deteriorates in performance or fails. Accordingly, according to some embodiments of the present disclosure, even when a failure occurs in the EPS system, deterioration in steering performance of a vehicle can be alleviated and serious safety problems can be prevented.

According to the above configuration, a vehicle body control system according to one aspect of the present disclosure, a control method of a vehicle body control system, and a non-transitory computer-readable storage medium storing a program for performing the method may alleviate deterioration of steering performance of the vehicle through one or more of a differential braking force and rear wheel steering when a failure occurs in an EPS system of the vehicle and power assist for a driver's steering is lost.

It should be understood that the effects of the present disclosure are not limited to the above-described effects and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A vehicle control system comprising:
a brake device configured to perform a brake operation of a vehicle;
a steering sensor configured to detect operation of a steering wheel of the vehicle; and
one or more controllers configured to:
detect a failure of an electric power steering (EPS) system;
determine a target yaw rate of the vehicle based on the detected operation of the steering wheel of the vehicle in response to detection of the failure of the EPS system; and
control the brake device to generate a differential braking force required for the determined target yaw rate of the vehicle when the failure of the EPS system is detected.

2. The vehicle control system of claim 1, wherein the one or more controllers are configured to:
when a direction of the determined target yaw rate of the vehicle is a direction in which the vehicle moves to a left, control the brake device to generate a left-sided differential braking force, and
when the direction of the determined target yaw rate of the vehicle is a direction in which the vehicle moves to a right, control the brake device to generate a right-sided differential braking force.

3. The vehicle control system of claim 1, wherein:
the steering sensor is configured to generate steering operation information based on the detected operation of the steering wheel of the vehicle,
the one or more controllers are configured to determine the target yaw rate of the vehicle based on the steering operation information, and
the steering operation information includes a rotation angle of the steering wheel and/or a torque of the steering wheel.

4. The vehicle control system of claim 1, wherein the one or more controllers are configured to receive final steering state information about the vehicle as feedback and use the final steering state information as a correction factor when generating the differential braking force.

5. The vehicle control system of claim 4, wherein the one or more controllers are configured to receive disturbance information related to an external action occurring while the vehicle is traveling and use the disturbance information as the correction factor when generating the differential braking force.

6. The vehicle control system of claim 5, wherein the disturbance information includes a friction force of a road on which the vehicle is traveling and/or a slope of the road.

7. The vehicle control system of claim 6, wherein the one or more controllers are configured to receive the final steering state information and the disturbance information through a controller area network (CAN) of the vehicle.

8. The vehicle control system of claim 1, wherein the one or more controllers are configured to control rear wheels of the vehicle such that the rear wheels of the vehicle are steered to a rear wheel steering angle required for the determined target yaw rate of the vehicle.

9. The vehicle control system of claim 8, wherein the one or more controllers are configured to generate rear wheel steering information including the rear wheel steering angle.

10. The vehicle control system of claim 9, wherein the one or more controllers are configured, when the detected operation of the steering wheel of the vehicle meets a predetermined condition, set the differential braking force to 0 and set the rear wheel steering angle to an angle opposite to a steering direction of the vehicle.

11. The vehicle control system of claim 10, wherein the detected operation of the steering wheel of the vehicle includes a rotation angle of the steering wheel, and the predetermined condition is set such that the rotation angle of the steering wheel is less than or equal to a predetermined angle.

12. The vehicle control system of claim 10, wherein the one or more controllers are configured to, when the detected operation of the steering wheel of the vehicle does not meet the predetermined condition, set the differential braking force to a value other than 0 and set the rear wheel steering angle to the angle opposite to the steering direction of the vehicle.

13. A method for controlling a vehicle, the method comprising:
detecting a failure of the EPS system;
detecting, by a steering sensor, operation of a steering wheel of a vehicle;
determining, by one or more controllers, a target yaw rate of the vehicle based on the detected operation of the steering wheel of the vehicle when the failure of the EPS system is detected; and
controlling, by the one or more controllers, a brake device to generate a differential braking force required for the determined target yaw rate of the vehicle when the failure of the EPS system is detected.

14. The method of claim 13, wherein the controlling of the brake device to generate the differential braking force required for the determined target yaw rate of the vehicle comprises:
when a direction of the determined target yaw rate is a direction in which the vehicle moves to a left, controlling the brake device to generate a left-sided differential braking force, and
when the direction of the calculated target yaw rate is a direction in which the vehicle moves to a right, controlling the brake device to generate a right-sided differential braking force.

15. The method of claim 13, further comprising controlling rear wheels of the vehicle such that the rear wheels of the vehicle are steered to a rear wheel steering angle required for the determined target yaw rate.

16. The method of claim 15, further comprising, when the detected operation of the steering wheel of the vehicle meets a predetermined condition, setting the differential braking force to 0 and setting the rear wheel steering angle to an angle opposite to a steering direction of the vehicle.

17. The method of claim 16, wherein the detected operation of the steering wheel of the vehicle includes a rotation angle of the steering wheel, and the predetermined condition is set such that the rotation angle of the steering wheel is less than or equal to a predetermined angle.

18. The method of claim 16, further comprising, when the detected operation of the steering wheel of the vehicle does not meet the predetermined condition, setting the differential braking force to a value other than 0 and setting the rear wheel steering angle to the angle opposite to the steering direction of the vehicle.

19. The method of claim 16, wherein:
the controlling of the brake device to generate the differential braking force required for the determined target yaw rate of the vehicle comprises controlling of the brake device to generate the differential braking force required for the determined target yaw rate of the vehicle using final steering state information about the vehicle and disturbance information related to an external action occurring while the vehicle is traveling as correction factors, and
the controlling of the rear wheels of the vehicle comprises controlling the rear wheels of the vehicle using the final steering state information and the disturbance information as the correction factors.

20. A non-transitory computer-readable storage medium storing instructions that, in response to execution by one or more processors, cause the one or more processors to perform operations comprising:
detecting a failure of the EPS system;
detecting operation of a steering wheel of a vehicle;
determining a target yaw rate of the vehicle based on the detected operation of the steering wheel of the vehicle when the failure of the EPS system is detected; and
controlling a brake device to generate a differential braking force required for the determined target yaw rate of the vehicle when the failure of the EPS system is detected.
